(19) United States
(12) Patent Application Publication
(10) Pub. No.: US 2003/0092192 A1
(43) Pub. Date: May 15, 2003

(54) Combustion gas detection system

(75) Inventors: James L. Pool, Clarinda, IA (US); Karan Pool, Clarinda, IA (US); Michael L. Whitehead, Clarinda, IA (US)

Correspondence Address: BANNER & WITCOFF, LTD., TEN SOUTH WACKER DRIVE, SUITE 3000, CHICAGO, IL, 60606, US

(73) Assignee: Lisle Corporation, Clarinda, IA

(21) Appl. No.: 10/324,899

(22) Filed: Dec. 20, 2002

Related U.S. Application Data
(63) Continuation-in-part of application No. 09/932,864, filed on Aug. 17, 2001.

(51) Int. Cl. G01N 31/12

(52) U.S. Cl. 436/143; 422/94

(57) ABSTRACT

A combustion gas detection apparatus includes a transparent tube partially filled with a combustion gas sensing fluid and an inlet fitting for engagement with the radiator cap of an engine cooling system and an outlet fitting for connection with a vacuum port of the engine or other vacuum source.

### CROSS REFERENCE TO RELATED APPLICATION

This is a continuation-in-part of application Ser. No. 09/932,864 filed Aug. 17, 2001 “Combustion Gas Detection System” incorporated herewith by reference and for which is claimed.

### BACKGROUND OF THE INVENTION

In a principal aspect the present invention relates to a combustion gas detection system for use in detecting undesired combustion gases in the coolant of the cooling system for an internal combustion engine.

When servicing an internal combustion engine of a motor vehicle, a mechanic or vehicle service technician often finds that it is appropriate or desirable to investigate whether the exhaust system is leaking combustion gases into the coolant of the cooling system. For example, a crack in the vehicle engine block may result in the transmission of combustion gases into the coolant liquid of the engine cooling system. Obviously, such a condition is very undesirable and indicates a necessity for potential repair or replacement of the engine block, engine head, or other potential sources of combustion gas leakage into the cooling system.

Heretofore, a method and apparatus for detection of such combustion gases involved suction of gases from the radiator outlet of an engine cooling system by squeezing a bulb to withdraw the gases through a container of gas sensitive fluid. The mechanic or technician would rapidly pump on the rubber bulb in order to withdraw the gases through the fluid. The fluid, being sensitive to the combustion gases, would reveal the presence of combustion gases by a change of color, for example.

While such a system has proven to be useful in detecting gases, there has remained a need for an improved apparatus and method for investigating the presence of combustion gases in the coolant fluid of a cooling system for an internal combustion engine.

### SUMMARY OF THE INVENTION

Briefly, the present invention comprises a combustion gas detection system which includes a transparent or translucent tube filled with combustion gas sensitive fluid. The tube includes an inlet fitting at one end which is adapted to engage and seal with the radiator cap opening of a vehicle cooling system. A check valve in a passage through the fitting leading from the radiator cap opening into the tube prevents backflow of fluid from the tube and permits inflow of gas from the cooling system. An outlet fitting for the fluid containing tube includes a flexible suction hose or conduit adapted to engage with a vacuum port of the vehicle engine. By engaging the engine vacuum port, the flexible conduit enables suction of gas from the cooling system through the transparent tube and the fluid in the tube.

When testing for combustion gas utilizing the device of the invention, the technician will start the internal combustion engine and permit it to warm to normal operating temperature. Some of the coolant fluid is removed from the cooling system so that there is a region of gas above the fluid level within the radiator. The inlet fitting of the fluid filled transparent tube is then engaged over the radiator cap opening. An engine vacuum port is connected with the suction hose from the transparent tube to thereby draw gas from the cooling system through the transparent tube. The gas sensitive fluid within the detection device transparent tube typically will change color as combustion or exhaust gases react therewith to alter the pH of the fluid. By way of example, the fluid within the detection device transparent tube may be a mixture of bromothymal blue, sodium monocarbonate and water. The presence of excess carbon dioxide and/or carbon monoxide will cause such a solution to alter color from a blue color to a yellow hue thereby suggesting a combustion gas leak into the vehicle cooling system.

When attempting to troubleshoot the operation of an internal combustion engine by locating the cylinder or cylinders wherein the source of combustion gas leakage occurs, removal of the ignition spark associated with each cylinder may be effected. By removing the ignition mechanism associated with one or more cylinders, a mechanic will remove that cylinder or cylinders as an exhaust gas source and by process of elimination will be able to identify whether a particular cylinder is the source of the undesired combustion gas.

The system may be modified to provide for detection of combustion gases in the cooling system of a diesel engine by providing a more highly sensitive gas detection fluid in the transparent tube and a hand or other external vacuum pump instead of a connection hose to an engine vacuum source. Also, in any of the embodiments of the invention, the vacuum may be controlled by providing sized openings in the vacuum tube. Such control may be desirable to prevent suction of fluid from the transparent tube.

Thus, it is an object of the invention to provide an improved combustion gas detection apparatus or system and method for use with internal combustion engines.

A further object of the invention is to provide a combustion gas detection apparatus which is easy to use, foolproof, rugged and economical.

Another object of the invention is to provide a combustion gas detection method and apparatus useful with gas and diesel internal combustion engines.

These and other objects, advantages and features of the invention will be set forth in a detailed description which follows.

### BRIEF DESCRIPTION OF THE DRAWING

In the detailed description which follows, reference will be made to the drawing comprised of the following figures:

FIG. 1 is a plan view of the apparatus of the invention depicted in combination with various components of a gas internal combustion engine;

FIG. 2 is an isometric view of the apparatus of the invention as it is used in combination with a gas internal combustion engine for detection of combustion gas; and

FIG. 3 is a plan view of an alternative configuration of the apparatus of the invention depicted in combination with various components of a diesel internal combustion engine.

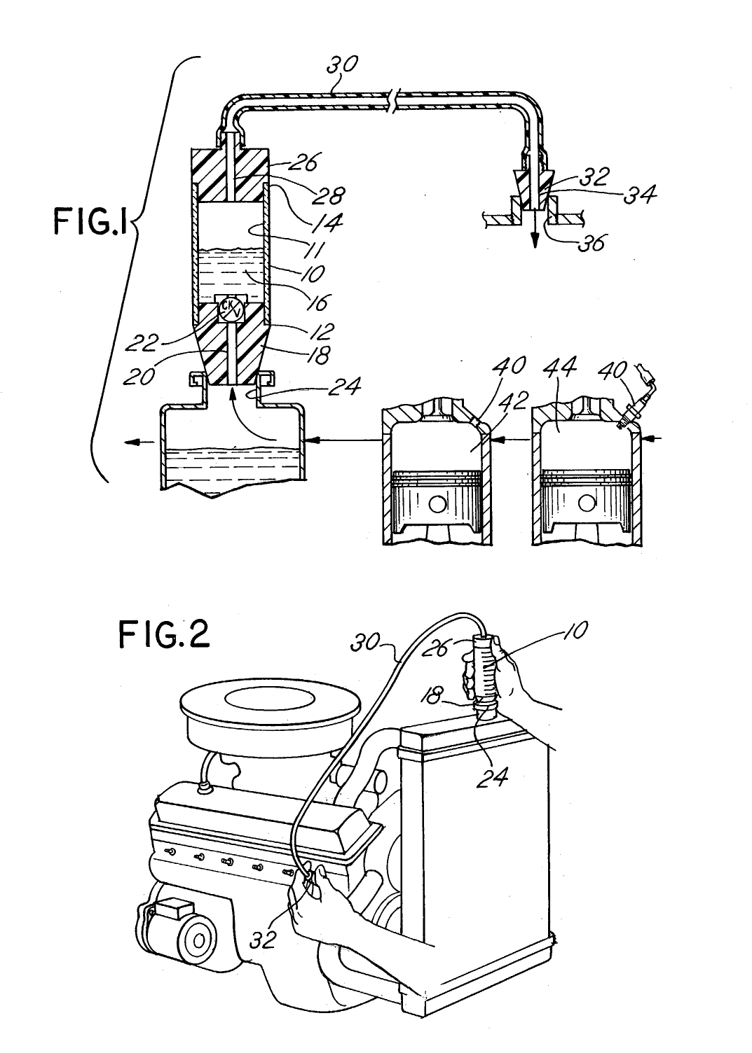

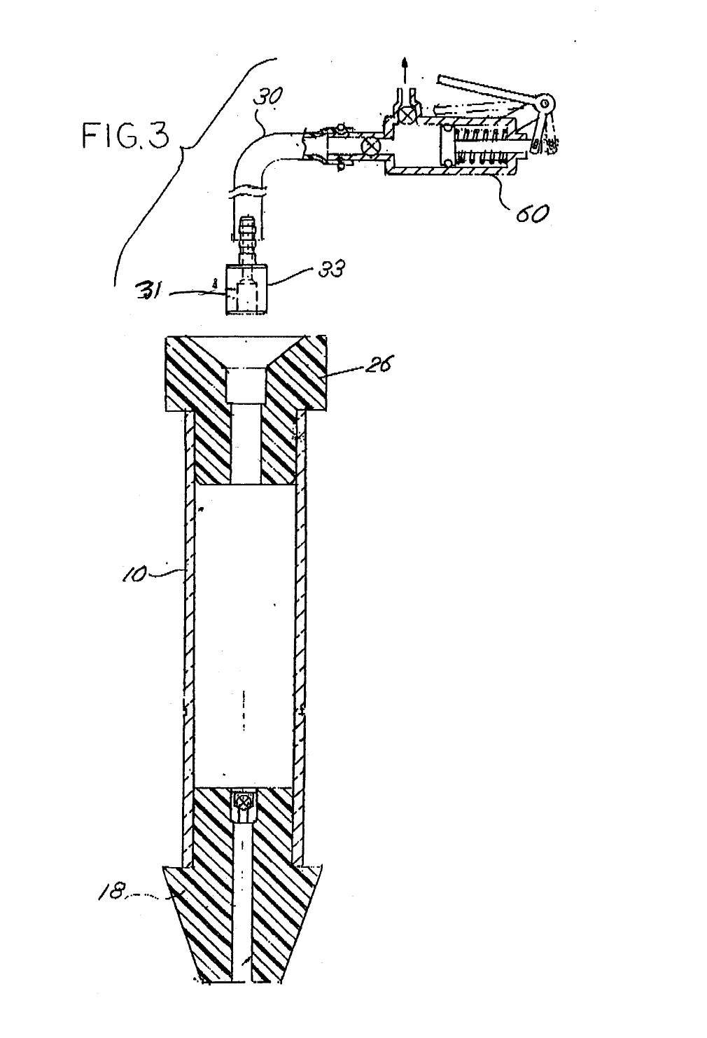

### DESCRIPTION OF THE PREFERRED EMBODIMENT

Referring to the figures, the combustion gas detection apparatus includes a main cylindrical tube 10 having an inlet end 12 and an outlet end 14. Preferably, the tube 10 is translucent or transparent. Most preferably, the tube is transparent in order that one might easily observe the color change of fluid 16 within the tube 10. Various indicia may be provided in the side of the tube 10 to indicate the level of fluid therein.

An inlet fitting 18 is provided at the inlet end 12 of the tube 10. The inlet fitting 18 includes a throughpassage 20 with a check valve 22 therein. The check valve 22 permits movement of gas into the tube 10 and prevents backflow of liquid, gas sensitive fluid 16 from the tube 10 through the passageway, or throughpassage 20. Typically, the fitting 18 is made from an elastomeric material in order that it might tightly seal against an opening associated with a cooling system, for example, a radiator opening 24.

An outlet fitting 26 is provided at the outlet end 14 of the tube 10. The outlet fitting 26 includes a throughpassage 28 leading from the interior or reservoir 11 of the tube 10. A flexible conduit or hose, for example, rubber or Tygon plastic tubing 30 is fitted into the outlet fitting 26 and is connected with the passage 28. The tubing 30 or end fitting 33 may include a port or opening 31 sized to control the vacuum in tubing 30 so that sensing fluid 16 will not be drawn or sucked into tube 30. The opposite end of the tubing or conduit 30 includes a vacuum port connector or fitting 32 with a passage 34 therethrough. The vacuum port fitting 32 is preferably an elastomeric fitting so that it may be sealed in a vacuum port of a gas internal combustion engine, for example, vacuum port 36.

The combustion gas sensitive fluid 16 is retained within the reservoir 11 of the tube 10. For example, the fluid 16 may be the following mix: bromothymal blue, sodium monocarbonate and water. However, other combustion gas sensitive fluids may be used. The particular combustion gas sensitive material identified will change color from blue to yellow upon sensing of combustion gases, that is carbon dioxide and/or carbon monoxide.

The sensitivity of fluid 16 may be adjusted or controlled by choice of fluid 16. For example, gas internal combustion engines typically provide an exhaust which is about 15% CO₂. Diesel exhaust is about 5% CO₂. Thus, the choice of the sensitivity of fluid 16 may be determined by the type of engine being tested. Following are examples of fluid useful in the use of the apparatus:

### EXAMPLE NO. 1

Gas Combustion Engine

A mixture of bromothymol blue supplied by Sigma Aldrich Chemical Company is mixed in distilled water with sodium carbonate to provide a gas sensitive solution.

### EXAMPLE NO. 2

Diesel Engine

A mixture of cresol red supplied by Sigma Aldrich Chemical Company is mixed in distilled water with sodium carbonate derived from washing soda to provide a diesel exhaust gas sensitive solution.

FIG. 3 illustrates an alternative embodiment useful with diesel engines. A tube 10 with a fitting 18 is designed to engage the radiator opening. Outlet fitting 26 connects via tubing 30 to a hand vacuum pump 60 or other external vacuum source since diesel engines do not typically include an appropriate vacuum port. Also, the fitting 33 or tubing 30 for diesel engine exhaust detection does not typically include a hole 31 because of the lower vacuum level associated with a hand vacuum pump.

In operation, after removal of some of the cooling fluid from the vehicle radiator, the inlet fitting 18 is sealed against the open radiator cap fitting 24 prior to or subsequent to starting of the vehicle engine. The engine is then run so that it is operating at its normal operating temperature. This permits normalized access to any gases that may be in the coolant cycling through the cooling system. The vacuum port fitting 32 is then placed into a vacuum port 36 of the engine (or tube 30 is connected to vacuum pump 60 for a diesel engine). There are many such vacuum ports on internal combustion engines and any one of them can be used for this purpose. Connecting the vacuum port fitting 32 to the vacuum port 36 will effect a flow of gas through the passage 20, check valve 22, fluid 16 and then through the passage 28 and conduit 30. As the gas flows through the detection fluid 16, it will react therewith, assuming it is combustion gas, as evidenced by a color change in the fluid 16. The gas that is leaking into the coolant would, in all likelihood, be from the engine block or some other similar source.

The combustion gas source may be detected by disengaging the ignition system with one or more of the engine cylinders. For example, an ignition system 40 associated with a gas combustion engine cylinder 42 may be disconnected. Thus, if combustion gas is detected when that cylinder is not firing, the combustion gas would be associated with another active cylinder 44 rather than the inactive cylinder 42. In this manner, a technician or mechanic may troubleshoot and determine the source of the combustion gas.

It is possible to vary the construction of the apparatus. The shape and size of the tube 10 may be varied. A series of tubes 10 may be provided filled with different fluids and separated by check valves to detect different levels and contaminants of gas. The shape and size of the various fittings may be altered. Connection of the vacuum port fitting to the internal combustion engine being checked may also be varied. That is, a separate vacuum port source may be utilized. Thus, the invention is to be limited only by the following claims and equivalents thereof.

What is claimed is:

1. An apparatus for detection of combustion gas in the coolant of an internal combustion engine, said engine, including an access opening to the cooling system, said apparatus comprising, in combination:
a transparent reservoir member having an entry passage fitting and an exit passage, said entry passage fitting configured for sealing with the engine cooling system access opening, said entry fitting including a through passage to the interior of the reservoir with a check valve in the through passage that precludes fluid flow from the reservoir through the check valve;
a vacuum tube connectable from the reservoir member exit passage to a vacuum source; and
a gas sensitive fluid in the reservoir which changes appearance upon contact with combustion gases.

2. The apparatus of claim 1 wherein the fluid is a mixture of bromothymal blue, sodium monocarbonate and water.

3. The apparatus of claim 1 wherein the vacuum tube includes an end fitting for engagement with a vacuum port of the engine.

4. The apparatus of claim 1 wherein the reservoir is a cylindrical tube with a fitting at each end.

5. An apparatus for detection of combustion gas in the coolant system of an internal combustion engine, said system including a coolant access opening, said apparatus comprising, in combination:
a transparent tube having an inlet passage and an outlet passage;
a suction conduit connected to the tube outlet passage;
a vacuum port connector attached to the suction conduit for connecting the suction conduit to a vacuum source;
a check valve in the tube inlet passage for blocking fluid flow from the tube and for permitting gas flow into the tube from the inlet passage;
a fitting attached to the tube inlet passage for connection of the inlet passage with the coolant access opening; and
a combustion gas sensitive fluid in the tube responsive visually to the presence of combustion gas transported from the cooling system through the apparatus tube inlet fitting into the fluid in response to vacuum suction through the suction conduit connected to a vacuum source.

6. The apparatus of claim 5 wherein the fluid is a mixture of bromothymal blue, sodium monocarbonate and water.

7. The apparatus of claim 5 wherein the fluid is sensitive to carbon dioxide, carbon monoxide, or mixtures thereof.

8. A method for detection of combustion gases in the coolant system of a diesel internal combustion engine of the type having an access opening to the cooling system and an engine vacuum port, said method comprising the steps of:
providing a detection apparatus having a transparent tube filled inside, at least in part, with combustion gas sensitive fluid; said tube including an inlet fitting with a throughpassage to the tube, the throughpassage including a check valve to block fluid flow from the tube, and a vacuum conduit from the tube;
operating the engine with an open cooling system access opening;
connecting the vacuum conduit to a vacuum source, connecting the inlet fitting to the cooling system access opening to thereby draw a gas flow from the cooling system through the fluid; and
observing the fluid to detect any visual change indicative of combustion gas derived from the cooling system.

9. The method of claim 8 including the step of disconnecting one or more engine cylinders from its combustion cycle whereby the disconnected cylinder will be eliminated or identified as a combustion gas source.

10. The apparatus of claim 1 or claim 5 wherein the apparatus alternatively includes means for connecting the conduit to a vacuum port of the engine or an external vacuum source.

11. The apparatus of claim 1 or claim 5 further including a hole in the vacuum to control the level of vacuum.

12. The apparatus of claim 1 or claim 5 wherein the fluid is a mixture of cresol rd, carbonate and water.
